(19) United States
(12) Patent Application Publication
(10) Pub. No.: US 2003/0223539 A1
(43) Pub. Date: Dec. 4, 2003

(54) Method and apparatus for acquiring and storing multiple offset corrections for amorphous silicon flat panel detector

(76) Inventors: Paul R. Granfors, Sunnyvale, CA (US); Richard Aufrichtig, Mountain View, CA (US)

Correspondence Address: MCANDREWS HELD & MALLOY, LTD, 500 WEST MADISON STREET, SUITE 3400, CHICAGO, IL, 60661

(21) Appl. No.: 10/063,978

(22) Filed: May 31, 2002

(51) Int. Cl. H05G 1/64

(52) U.S. Cl. 378/98.8

(57) ABSTRACT

An x-ray system used to acquire successive images is provided. The x-ray system includes an x-ray source for generating x-rays which are detected by a detector. The detector comprises detector elements that store levels of charge and are arranged in rows and columns. An image processor is used to sense the levels of charge stored by the detector elements. First and second offset image memories are included in the image processor. The first offset image memory stores offset image data for a first mode of operation and a second offset image memory stores offset image data for a second mode of operation.

### BACKGROUND OF INVENTION

Certain embodiments of the present invention generally relate to x-ray systems utilizing a solid state multiple element x-ray detector for producing an image; and more particularly, to techniques and apparatus for acquiring and storing offset image correction data for more than one mode of operation.

Solid state x-ray detectors comprising a two dimensional array of detector elements arranged in rows and columns are known in the art. A scintillator, such as cesium iodide (CsI), is deposited over the detector elements. The CsI absorbs x-rays and converts the x-rays to light. Each detector element comprises a photodiode and a field effect transistor (FET). The photodiode detects light, converts the light to a charge representative of an amount of radiation incident on the detector element and stores the charge. The FET operates as a switch to enable and disable read out of the charge stored on the photodiode. Each detector element is connected to both a row select line and a column signal line. The row select lines and column signal lines are used to activate the FET and read the level of stored charge in the photodiode. The detector may be designed with a split in each signal line at the midpoint, effectively splitting the reading of the detector into two separate operations. After an exposure, the detector is read on a row by row basis. With a detector that has split data lines, two rows may be read at the same time utilizing two sets of read out electronics. The data is then digitized for further image processing, storage, and display.

The signal of each detector element (or pixel) may include an offset which is independent of x-ray exposure. This offset has several sources including leakage current in the photodiodes and charge retention in the FET switches. At low signal levels, such as those used in fluoroscopic imaging, the magnitude of the offset may be larger than the x-ray signal. Furthermore, the offset is not uniform, but varies from pixel to pixel. This pixel-dependent offset is subtracted from the x-ray exposed image to produce a corrected image before viewing.

The offset may be isolated from the x-ray induced signal by acquiring a dark image, or an image when the detector is not exposed to x-rays. In order for the signals in the dark image to match the offset signals in the x-ray image, the dark image is acquired using the same mode of operation used to acquire the x-ray image. Because there is noise associated with the offset signals, a single dark image subtracted from an x-ray image may introduce additional noise into the corrected image. To reduce the amount of noise, several dark images may be averaged together to obtain a low-noise offset image. Additionally, the offset signals may drift with time, temperature, and other external factors. Therefore, the offset image must be updated periodically. The offset image for the mode of operation currently in use is typically updated shortly before or after an x-ray image is acquired when the x-ray signal is not present.

During fluoroscopy, it is often advantageous to switch between modes of operation. For example, in one mode of operation, the system may utilize only a portion of the detector, such as the center, if interested in anatomy that does not require the entire field of view. In another mode of operation, the entire field of view may be imaged with a lower resolution (larger pixel size). However, current x-ray systems store only one offset correction applicable for one mode of operation. Thus, every time the mode of operation is switched, the x-ray system must stop acquiring x-ray images in order to acquire the dark images used to create the new offset correction image. During this time, the x-ray system is no longer acquiring and displaying patient data, and thus the radiologist may need to halt the procedure until the x-ray system has completed acquiring the correction data and is ready to acquire patient data again.

Thus, a need exists in the industry for an x-ray system designed to switch between multiple modes of operation without interrupting the acquisition of patient data, to address the problems noted above and previously experienced.

### SUMMARY OF INVENTION

In accordance with at least one embodiment, an x-ray system is provided to acquire successive images. The x-ray system includes an x-ray source to generate x-rays which are detected by a detector. The detector comprises detector elements which store levels of charge and are arranged in rows and columns. An image processor is used to sense levels of charge stored by the detector elements. First and second offset image memories are included in the image processor. The first offset image memory stores offset image data based on levels of charge for a first mode of operation and a second offset image memory stores offset image data based on levels of charge for a second mode of operation.

In accordance with at least one embodiment, a method for acquiring successive x-ray images using multiple modes of operation is provided. A first mode of operation comprising identifying detector elements of an x-ray detector is selected. The detector elements are used to create an image. A first offset image corresponding to the first mode of operation is selected from a plurality of stored offset images, where the plurality of stored offset images corresponds to a plurality of modes of operation. The x-ray detector is exposed to a radiation source and the detector elements store a level of charge representative of the level of radiation detected. A first image representative of the levels of charge stored by the detector elements is acquired. The first offset image is then utilized to process the first image.

In accordance with at least one embodiment, a method for acquiring and storing multiple offset images for an x-ray system is provided. A first mode of operation identifying detector elements included in an x-ray detector and used to create an image is defined. A first dark image representative of levels of charge stored by the detector elements is acquired when the x-ray detector is not exposed to radiation and stored in a first memory. A second mode of operation is defined which is different from the first mode of operation. A second dark image representative of the levels of charge stored by the detector elements is acquired when the x-ray detector is not exposed to radiation and stored in a second memory.

### BRIEF DESCRIPTION OF DRAWINGS

The foregoing summary, as well as the following detailed description of certain embodiments of the present invention, will be better understood when read in conjunction with the appended drawings. It should be understood, however, that the present invention is not limited to the arrangements and instrumentality shown in the attached drawings.

FIG. 1 illustrates a block diagram of an x-ray system in accordance with an embodiment of the present invention.

FIG. 2 illustrates the circuitry of an exemplary portion of the photodetector array which is formed by a matrix of detector elements in accordance with an embodiment of the present invention.

FIG. 3 illustrates a block diagram of an offset correction system utilizing two offset image memories and multiple recursive filters in accordance with an embodiment of the present invention.

FIG. 4 illustrates a block diagram of an offset correction system utilizing two offset image memories and a single recursive filter in accordance with an embodiment of the present invention.

FIG. 5 illustrates a flow chart of the steps used to acquire, store and update the offset image, and to correct an incoming x-ray image using the stored offset image in accordance with an embodiment of the present invention.

### DETAILED DESCRIPTION

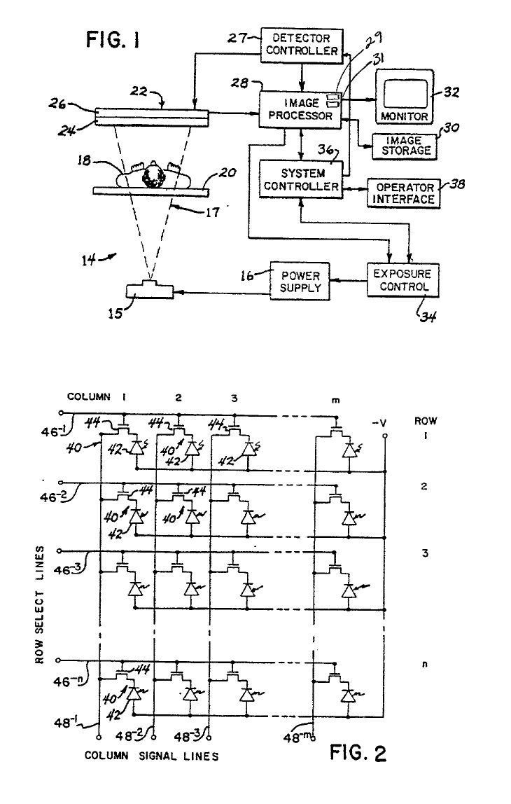

FIG. 1 illustrates a block diagram of an x-ray system 14. The x-ray system 14 includes an x-ray tube 15 which, when excited by a power supply 16, emits an x-ray beam 17. As illustrated, the x-ray beam 17 is directed toward a patient 18 lying on an x-ray transmissive table 20. The portion of the beam 17 which is transmitted through the table 20 and the patient 18 impinges upon an x-ray detector 22. The x-ray detector 22 comprises a scintillator 24 that converts the x-ray photons to lower energy photons in the visible spectrum. Contiguous with the scintillator 24 is a photodetector array 26 which converts the light photons into an electrical signal. A detector controller 27 contains electronics for operating the detector array 26 to acquire an image and to read out the signal from each photodetector element.

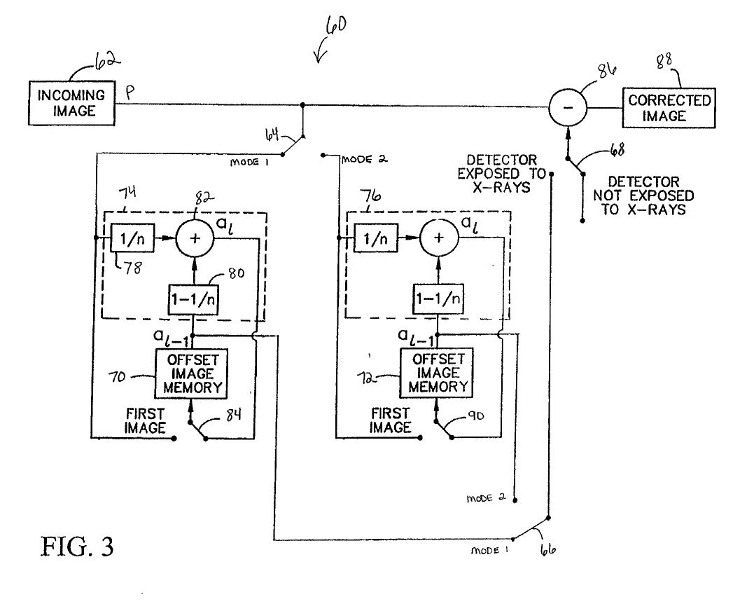

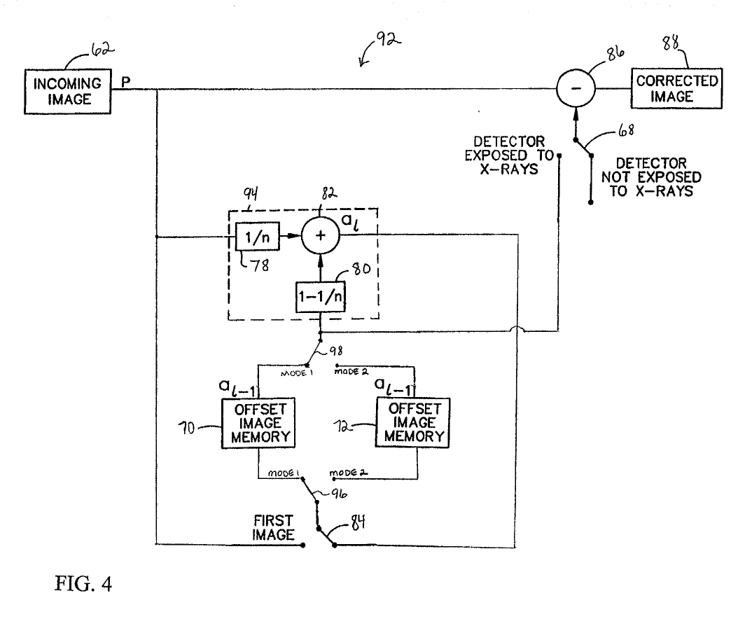

The output signal from the photodetector array 26 is coupled to an image processor 28 that includes circuitry for processing and enhancing the x-ray image signal. The image processor 28 includes at least two memories 29 and 31 for storing offset correction data. The memories 29 and 31 store a minimum of two offset images. The image processor 28 further includes one or more recursive filters as illustrated and discussed in relation to FIG. 3 and FIG. 4. The processed image is displayed on a video monitor 32 and may be archived in an image storage device 30. The image processor 28 may additionally produce a brightness control signal which is applied to an exposure control circuit 34 to regulate the power supply 16 and thereby the x-ray exposure. The overall operation of the x-ray system 14 is governed by a system controller 36 that receives commands from an x-ray technician via an operator interface panel 38.

FIG. 2 illustrates the circuitry of the photodetector array 26, which is formed by a matrix of detector elements 40. The detector elements 40 are arranged on an amorphous silicon wafer in a conventional two-dimensional array of m columns and n rows, where m and n are integers. For example, a typical high resolution x-ray detector is a square array of 1,000 to 4,000 rows and columns of elements. Each detector element 40 includes a photodiode 42 and a thin film transistor (TFT) 44. The photodiodes 42 are fabricated from a large wafer area in order that the photodiode 42 will intercept a sizeable portion of the light produced by the scintillator 24. Each photodiode 42 also has an associated capacitance that allows it to store the electrical charge resulting from the photon excitation.

The cathode of the photodiodes 42 in each column of the array 26 is connected by the source-drain conduction path of the associated TFT 44 to a common column signal line (48⁻¹ through 48^{-m}) for the column. For example the photodiodes 42 in column 1 are coupled to the first signal line 48⁻¹. The anodes of the diodes in each row are connected in common to a source of a negative bias voltage (−V). The gate electrodes of the TFTs 44 in each row are connected to a common row select line (46⁻¹ through 46⁻ⁿ), such as line 46⁻¹ for row 1. The row select lines (46⁻¹ through 46⁻ⁿ) and the column signal lines (48⁻¹ through 48^{-m}) are coupled to the detector controller 27 and the column signal lines (48⁻¹ through 48^{-m}) also are connected to the image processor 28.

In order to acquire an x-ray image using the detector 22 illustrated in FIG. 1, the x-ray system 14 performs the following sequence of operations. Initially, the detector controller 27 connects all the column signal lines (48⁻¹ through 48^{-m}) to ground and applies a positive voltage (Vₒₙ) to all the row select lines (46⁻¹ through 46⁻ⁿ). The positive voltage applied to the row select lines (46⁻¹ through 46⁻ⁿ) turns on the TFT 44 in each detector element 40, placing a positive charge on the reverse biased photodiodes 42. Once the photodiodes 42 have been fully charged, the detector controller 27 applies a negative voltage (−V_{off}), which is more negative than the negative supply voltage (−V), to the row select lines (46⁻¹ through 46⁻ⁿ). This negative biasing of the row select lines (46⁻¹ through 46⁻ⁿ) turns off the TFT 44 in each detector element 40.

The system x-ray tube 15 then generates an x-ray beam 17 and exposes the detector 22 to a pulse of x-ray photons. The x-ray photons are converted to lower energy photons by the scintillator 24. When these lower energy photons strike the photodiodes 42 in the detector 26, the electron-hole pairs are liberated and stored in the capacitance of the photodiode. The amount of charge stored in the given photodiode 42 depends upon the amount of lower energy photons which strikes it, which in turn depends upon the intensity of the x-ray energy that strikes the region of the scintillator 24 adjacent to the photodiode 42. Therefore, the amount of charge stored in the photodiode 42 in each detector element 40 is a function of the x-ray intensity striking the corresponding region of the x-ray detector 22.

After the termination of the x-ray exposure, the residual charge in each photodiode 42 is sensed. If a dark image, rather than an x-ray image, is to be acquired, the detector 22 is not exposed to a pulse of x-ray photons before the residual charge in each photodiode 42 is sensed. To sense the charge, the column signal line (48⁻¹ through 48^{-m}) for each detector array column is simultaneously connected to separate sensing circuits in the image processor 28. Any of several types of sensing circuits may be incorporated into the image processor 28. For example, the sensing circuit may measure the voltage across the photodiode 42, and therefore the amount of charge stored in the photodiode 42. Alternatively, the sensing circuit may connect the associated column signal line (48⁻¹ through 48^{-m}) to a lower potential than the cathode of the photodiode 42 and measure the amount of charge that flows to or from the photodiode 42.

The photodiode charges may be sensed a row at a time by the detector controller 27 sequentially applying the positive voltage (Vₒₙ) to each of the row select lines (46⁻¹ through 46⁻ⁿ). When a row select line (46⁻¹ through 46⁻ⁿ) is positively biased, the detector array TFTs 44 connected to that row select line (46⁻¹ through 46⁻ⁿ) are turned on thereby coupling the associated photodiodes 42 in the selected row to their column signal lines (48⁻¹ through 48^{-m}).

In order to decrease the amount of time required to read out the signal from each detector element 40 in the photodetector array 26, the rows of detector elements 40 can be divided into two groups and each group simultaneously read out by separate signal sensing circuits. For example, if the detector 22 is split into two halves, the detector elements 40 in the top half of the photodetector array 26 may be read out simultaneously with the detector elements 40 in the bottom half of the photodetector array 26.

FIG. 3 illustrates a block diagram of an offset correction system 60 utilizing two offset image memories 70 and 72 and recursive filters 74 and 76. The recursive filters 74 and 76 process offset image correction data for different modes of operation. One mode of operation may acquire data from a region of interest, or a portion of the detector, such as a 1024×1024 sized matrix of pixels arranged symmetrically around the split in the detector 22. In this mode, every row within the selected portion of the detector 22 is read out individually. Another mode of operation may acquire image data with lower resolution and utilize “binning”, wherein multiple pixels are combined to create one pixel value. Binning may be used when acquiring data from the entire field of view of the detector 22 or from a region of interest. For example, a high resolution image may not be required, or a higher frame rate than the frame rate available during high resolution imaging may be desired. Therefore, adjacent rows are read out at the same time, and a small number of neighboring pixels, such as four pixels, are combined to create a matrix with a lower resolution. Additional modes of operation may be utilized, such as selecting a region of interest other than the center of the detector 22, imaging using a low dose or a high dose of x-ray requiring the use of different gain settings, or changing the sequence or timing in which the detector elements 40 are read. For each additional mode of operation, an additional offset image memory 70 and 72 may be included.

An x-ray detector 22 produces incoming images 62 at a given frame rate. By way of example only, for fluoroscopy, a typical frame rate may be 30 images per second. The system controller 36 determines if detector 22 was exposed to x-rays. If the detector 22 was not exposed to x-rays, switch 68 is placed in a position indicating “detector not exposed to x-rays”. In this configuration incoming images 62, which are dark images or images not exposed to x-ray beam 17, are used to create or update an offset image stored in offset image memory 70 or 72.

The system controller 36 identifies the mode of operation, which may be changed by an operator through the operator interface 38. By way of example only, MODE 1 may be a reduced region of interest, such as a 1024×1024 matrix of pixels in the center of the detector 22, and MODE 2 may utilize binning and the entire field of view of the detector 22. The system controller 36 communicates to the image processor 28 which sets switch 64 according to the mode of operation. When switch 64 is set to MODE 1 and switch 68 is set to “detector not exposed to x-rays”, incoming image 62 will be processed by recursive filter 74 and stored in offset image memory 70. When switch 64 is set to MODE 2 and switch 68 is set to “detector not exposed to x-rays”, incoming image 62 will be processed by recursive filter 76 and stored in offset image memory 72. Because the operation of the illustrated offset image memories 70 and 72 and recursive filters 74 and 76 are the same, only offset image memory 70 and recursive filter 74 will be discussed. Optionally, recursive filters 74 and 76 may utilize one or more components in common.

At startup and at other times as necessary, the system controller 36 may operate the detector 22 in each mode of operation automatically. When MODE 1 is selected, switch 84 is put in a “first image” position. In this configuration, the incoming dark image replaces the contents of the offset image memory 70. Once the first dark image is stored, switch 84 is switched back to its original position, as illustrated in FIG. 3. Subsequently, one or more additional dark images are acquired. As each image is acquired, it is combined with the contents of the offset image memory 70 as discussed below. The process of acquiring initial and subsequent dark images in order to create an offset image is repeated for each mode of operation. Therefore, the acquisition of new and/or updated offset images may be transparent to the operator.

The recursive filter 74 acts as a temporal filter on the sequence of incoming successive images 62 to produce an offset image stored in the offset image memory 70. As each incoming image 62 is acquired, it is combined with the contents of the offset image memory 70 using the recursive filter 74. The action of this filter 74 can be described by the Equation 1 below:

aᵢ=(1−1/n)(aᵢ₋₁)+(1/n)p Equation 1

In Equation 1, p represents an incoming pixel value, (aᵢ₋₁) is the present pixel value in the offset image memory, and aᵢ is the output of the filter. It should be understood that the filter acts on each pixel, or combined pixels, if binning is used, and combines the input value of the incoming image 62, with the corresponding value in the offset image memory 70. The output of the filter, a for each pixel position, constitutes a new, reduced-noise offset image. This image is used to overwrite the previous contents, (aᵢ₋₁), of the offset image memory 70.

As shown in FIG. 3, the recursive filter 74 comprises multipliers 78 and 80 and adder 82. The multiplier 78 multiplies the pixel values in the incoming image 62 by a multiplier of 1/n. The multiplier 80 multiplies pixel values stored in the offset image memory 70 by a multiplier of (1−1/n). The results of both multipliers 78 and 80 are input to the adder 82 to generate an offset image which is stored in the offset image memory 70.

The value of n controls the amount of noise reduction and the speed of updating the offset image memory. Smaller values of n will produce faster updating but less noise smoothing, whereas larger values of n will produce slower updating and more smoothing. The recursive filter 74 is not limited to the components and calculations illustrated, and may achieve the noise reduction and automatic update by other suitable circuitry and/or software.

When the detector 22 is exposed to x-rays, the switch 68 is placed in a position indicating “detector exposed to x-rays”. With switch 68 in this position, the updating action of the recursive filters 74 and 76 is halted. The system controller sets switch 66, which determines whether offset image memory 70 will be utilized for MODE 1 or offset image memory 72 will be utilized for MODE 2. The offset image stored in the offset image memory 70 or 72 is subtracted from the incoming image 62 using the subtractor 86. The subtraction removes the offset signals from the x-ray image 62 and produces a corrected image 88. Therefore, by utilizing the offset images stored in the offset image memories 70 and 72, successive incoming images 62 may be processed and displayed on the monitor 32 without having to halt the acquisition of patient data when switching between modes of operation.

FIG. 4 illustrates a block diagram of an offset correction system 92 utilizing two offset image memories 70 and 72 and a single recursive filter 94. The recursive filter 94 processes offset image correction data for MODE I and MODE 2 to be stored in offset image memories 70 and 72, respectively. Similar to FIG. 3, an additional offset image memory 70 and 72 may be included for each additional mode of operation.

The x-ray detector 22 produces incoming images 62 at a given frame rate. If the detector 22 was not exposed to x-rays, switch 68 is set to “detector not exposed to x-rays”. The system controller 36 identifies the mode of operation and sets switches 96 and 98 accordingly. A first dark image is acquired and stored as needed in offset image memories 70 and 72 as previously discussed. The offset correction system 92 operates similar to offset correction system 60, except that the single recursive filter 94 is used to generate the offset images.

When the detector 22 is exposed to x-rays, the switch 68 is placed in the position indicating “detector exposed to x-rays”. The system controller sets switch 98, which determines whether offset image memory 70 will be utilized for MODE 1 or offset image memory 72 will be utilized for MODE 2. The offset image stored in offset image memory 70 or 72 is then subtracted from the incoming image 62 using the subtractor 86 to produced corrected image 88.

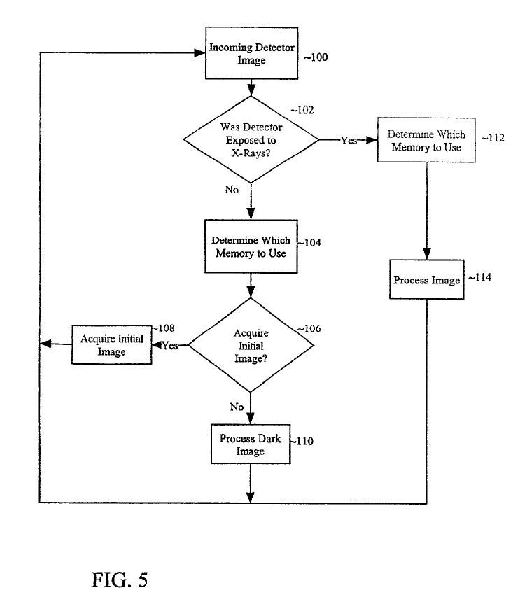

FIG. 5 illustrates a flow chart of the steps which may be used to acquire, store and update the offset image, and to correct an incoming x-ray image using the offset image. At step 100, the detector controller 27 initiates the acquisition of an image as previously discussed. The x-ray tube 15 may or may not be exposing the detector 22 to x-ray.

At step 102, the system controller 36 determines what mode of operation, and thus which offset image memory 70 and 72 in the image processor memories 29 and 31 will be used. For example, the system controller 36 may determine whether the center portion of the detector 22 is being imaged, or whether binning is utilized to image the entire detector 22. The mode of operation may be changed by the operator through the operator interface 38 before or during the diagnostic procedure as previously discussed. Because the x-ray system 14 utilizes more than one offset image memory 70 and 72 to store offset images for more than one mode, the mode of operation may be changed during a patient procedure without halting the acquisition of patient data. Once the mode of operation is determined, the system controller 36 sets switch 64 (FIG. 3) or switches 96 and 98 (FIG. 4) to the appropriate setting. For the following discussion, switches 64, 96 and 98 are set to MODE 1, as illustrated in FIG. 3 and 4.

At step 104, the system controller 36 determines whether the detector 22 was exposed to x-rays during the image acquisition. If no, the incoming image 62 is a dark image. Switch 68 is set to “detector not exposed to x-rays” and flow passes to step 106.

At step 106, the image processor 28 determines whether an initial dark image should be acquired. An initial dark image may be acquired when the x-ray system 14 is started, or when a predefined parameter has been met, such as a predefined length of time passing since the offset image was updated. If an initial image is to be acquired, flow passes to step 108, where the switch 84 is set to “first image”. After an initial dark image is acquired, switch 84 is returned to the position illustrated in FIG. 3 and 4. Flow then returns to step 100 to process the next incoming image 62. Alternatively, the system controller 36 may prevent subsequent x-ray exposure of detector 22 until a predetermined number of dark images have been acquired and processed for the mode of operation currently selected. If an initial image is not to be acquired at step 106, flow passes to step 110. The dark image is then processed by recursive filter 74, 94 and the updated offset image is stored in offset image memory 70 as discussed previously. Once again, the system controller 36 may prevent subsequent x-ray exposure of detector 22 until the predetermined number of dark images have been acquired and processed for the mode of operation currently selected.

If the system controller 36 determines at step 104 that the detector 22 has been exposed to x-rays, switch 68 is set to “detector exposed to x-rays” and flow passes to step 112. At step 112, the system controller 36 sets the switch 66 (FIG. 3) to the appropriate setting. Continuing the example above, switch 66 is set to MODE 1. The image processor 28 then subtracts the offset image stored in the offset image memory 70 from the incoming image 62 with subtractor 86. The result is the corrected image 88, which may be displayed on the monitor 32 and/or stored in the image storage 30. Flow then returns to step 100, where the next incoming image 62 is acquired.

As discussed above, by utilizing multiple offset image memories 70 and 72 to store offset image correction data, there is no need to halt the acquisition of patient data when the mode of operation is switched during a procedure. Multiple modes of operation may be utilized to acquire successive x-ray images during a single procedure without interruption. Therefore, the acquisition of patient data need not be halted to acquire additional offset correction data when switching between modes of operation. It should be understood that although two modes of operation and two corresponding offset image memories were discussed, the system and method may utilize more than two modes of operation and corresponding offset image memories and achieve the benefits described herein.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An x-ray system utilized to acquire successive images, the x-ray system comprising:
an x-ray source for generating x-rays;
a detector comprising detector elements arranged in rows and columns, said detector elements storing levels of charge; and
an image processor sensing levels of charge stored by said detector elements, said image processor including first and second offset image memories storing offset image data based on said levels of charge indicative of first and second modes of operation, respectively.

2. The x-ray system of claim 1, said image processor further comprising a recursive filter updating a first and second offset image when said detector is not exposed to said x-rays, said first and second offset images representative of said first and second modes of operation, respectively.

3. The x-ray system of claim 1, wherein a mode of operation comprises using a portion of said detector elements.

4. The x-ray system of claim 1, further comprising:
an operator interface for choosing a mode of operation; and
a system controller identifying said mode of operation, said system controller choosing one of said first and second offset image memories based on said mode of operation.

5. The x-ray system of claim 1, further comprising a system controller choosing an offset image memory based upon a mode of operation, said offset image memory storing an offset image, said image processor subtracting said offset image from an incoming image.

6. The x-ray system of claim 1, said image processor further comprising:
a first recursive filter updating a first offset image with at least one successive dark image when said detector is not exposed to said x-rays, said first offset image representative of said first mode of operation; and
a second recursive filter updating a second offset image with at least one successive dark image when said detector is not exposed to said x-rays, said second offset image representative of said second mode of operation.

7. The x-ray system of claim 1, wherein one of said first and second modes of operation combines said levels of charge stored by a plurality of said detector elements.

8. The x-ray system of claim 1, further comprising:
a system controller choosing an offset image memory based upon a mode of operation, said offset image memory storing an offset image; and
a recursive filter updating said offset image when said detector is not exposed to said x-rays.

9. The x-ray system of claim 1, further comprising a system controller identifying when said detector is exposed to said x-rays and choosing an offset image memory based on a mode of operation, said offset image memory storing an offset image, said image processor using said offset image to process an incoming x-ray image.

10. A method for acquiring successive x-ray images using multiple modes of operation, the method comprising:
selecting a first mode of operation, said first mode of operation identifying detector elements utilized to create an image, said detector elements included in an x-ray detector;
selecting a first offset image corresponding to said first mode of operation from a plurality of stored offset images, said plurality of stored offset images corresponding to a plurality of modes of operation;
exposing said x-ray detector to a radiation source, said detector elements storing a level of charge representative of a level of radiation detected by said detector elements;
acquiring a first image representative of said levels of charge stored by said detector elements; and
utilizing said first offset image to process said first image.

11. The method of claim 10, further comprising:
selecting a second mode of operation different from said first mode of operation;
selecting a second offset image corresponding to said second mode of operation from said plurality of stored offset images; and
processing a second image with said second offset image, said first and second images comprising successive images.

12. The method of claim 10, further comprising:
acquiring a first dark image and at least a second dark image when said x-ray detector is not exposed to said radiation source;
storing said first dark image as an offset image in a first offset image memory when said first mode of operation is selected, and
recursively filtering said offset image with said at least a second dark image to create an updated offset image.

13. The method of claim 10, wherein said first mode of operation comprises using each of said detector elements and a second mode of operation comprises using a portion of said detector elements.

14. The method of claim 10, said first offset image comprising a set of values wherein each value represents said levels of charge stored by a plurality of said detector elements.

15. The method of claim 10, further comprising:
recursively filtering said first offset image to create an updated offset image when said x-ray detector is not exposed to x-rays; and
storing said updated offset image in an offset image memory corresponding to said first mode of operation.

16. A method for acquiring and storing multiple offset images for an x-ray system, the method comprising:
defining a first mode of operation, said first mode of operation identifying detector elements utilized to create an image, said detector elements included in an x-ray detector;
acquiring a first dark image representative of levels of charge stored by said detector elements when said x-ray detector is not exposed to radiation;
storing said first dark image as an offset image in a first offset image memory corresponding to said first mode of operation;
defining a second mode of operation different from said first mode of operation;
acquiring a second dark image representative of the levels of charge stored by said detector elements when said x-ray detector is not exposed to radiation; and
storing said second dark image as a second offset image in a second offset image memory corresponding to said second mode of operation.

17. The method of claim 16, further comprising:
acquiring a dark image representative of levels of charge stored by said detector elements after an x-ray exposure has terminated; and
recursively filtering said dark image to create an updated offset image corresponding to a mode of operation utilized during said x-ray exposure.

18. The method of claim 16, wherein one of said first and second modes of operation combines said levels of charge stored by a plurality of said detector elements.

19. The method of claim 16, further comprising:
acquiring a first series of successive dark images utilizing said first mode of operation;
processing said first series with a recursive filter to create a first updated offset image;
acquiring a second series of successive dark images utilizing said second mode of operation; and
processing said second series with said recursive filter to create a second updated offset image.

20. The method of claim 16, wherein one of said first and second modes of operation comprises using a portion of said detector elements.
